(19) United States
(12) Patent Application Publication
(10) Pub. No.: US 2024/0391217 A1
(43) Pub. Date: Nov. 28, 2024

(54) VEHICLE LAMINATED GLAZING

(71) Applicant: AGC GLASS EUROPE, Louvain-la-Neuve (BE)

(72) Inventors: Xavier DARDENNE, Grez-Doiceau (BE); Gerard DALMAU BARCONS, Gosselies (BE)

(73) Assignee: AGC GLASS EUROPE, Louvain-la-Neuve (BE)

(21) Appl. No.: 18/696,663

(22) PCT Filed: Sep. 26, 2022
(86) PCT No.: PCT/EP2022/076628

§ 371 Date: Mar. 28, 2024

(30) Foreign Application Priority Data
Oct. 7, 2021 (EP) 21201533.3

(51) Int. Cl. B32B 17/10

(52) U.S. Cl. CPC B32B 17/10385; B32B 17/10036; B32B 17/10761; B32B 2605/08

(57) ABSTRACT

A heatable wired vehicle laminated glazing configured to be used in front of an on-board-unit able to emit and receive radio-frequency signals in the 5.9 GHz band. The vehicle laminated glazing has conductive wires configured to heat the vehicle laminated glazing. These conductive wires have a wave factor (WF) defined as the ratio between the wire length (L) over one period and the wavelength (λ). These conductive wires are spaced by a pitch (P) between

$${P}_{min} = \frac{2.9}{WF + 0.1} + 0.3 and {P}_{max} = \frac{4.3}{WF + 0.1} + 0.5 .$$

### FIELD OF THE INVENTION

The present invention relates to the field of radio-frequency (RF) communication received & transmitted by a vehicle. More specifically it relates to a heatable wired automotive laminated glazing allowing such communication.

### BACKGROUND OF THE INVENTION

Nowadays radio-frequency (RF) communication from and to vehicles is of particular interest.

Vehicle-to-everything (V2X) is communication between a vehicle and any entity that may affect, or may be affected by, the vehicle. It is a vehicular communication system that incorporates other more specific types of communication as V2I (vehicle-to-infrastructure), V2N (vehicle-to-network), V2V (vehicle-to-vehicle), V2P (vehicle-to-pedestrian), V2D (vehicle-to-device) and V2G (vehicle-to-grid).

The main motivations for V2X are road safety, traffic efficiency, and energy savings. There are two competing V2X solutions. The first one is based on an extended WiFi protocol (802.11p), e.g. ITS-G5, for direct link only, working in the 5.9 GHz band. The other one is based on 3GPP C-V2X having two communication channels: a direct link in the 5.9 GHz band (PC5 interface) and through the network link, i.e. using classical 4G/5G bands (Uu interface). We focus here on direct link communication (5.9 GHz band), applicable to both ITS-G5 or 3GPP C-V2X standards. Dedicated Short Range Communications (DSRC) is an open-source protocol for wireless communication, intended for highly secure, high-speed V2X communication. DSRC is a one-way or two-way short-range to medium-range wireless communication channels specifically designed for automotive use and a corresponding set of protocols and standards. It is known as operating between 5.85 and 5.93 GHz, which is referred to as the 5.9 GHz band.

802.11p is the basis for DSRC, a U.S. Department of Transportation project based on the Communications Access for Land Mobiles architecture of the International Organization for Standardization for vehicle-based communication networks, particularly for applications such as commerce transactions via vehicles (for example toll collection) and vehicle safety services. Such network enables communications between vehicles and roadside access points or other vehicles. In Europe, 802.11p is used as a basis for the ITS-G5 standard, supporting the GeoNetworking protocol for vehicle to vehicle and vehicle to infrastructure communication.

Electronic tolling (e-tolling) has become more and more used in the automotive industry. E-tolling is indeed an efficient way for highway users to pay for the tolled roads, bridges and tunnels they drive. Systems for such road user charging have been in operation on many locations around the world. Due to increasing congestion of roads and highways and the associated environmental influences, there is an increased focus all over the world on trying to implement regulations that may reduce the amount of vehicle traffic. Levying road user charges is an option, and automated systems for easy and effective payment of road user charges are commercially available today and are also under continuous development.

More generally, commerce transactions via vehicles can also be used to pay at gas stations as well as at electric stations (V2G), at drive-in (restaurant, drugstore, . . . ).

One way of identifying a vehicle that is passing a charging point is by equipping the cars with an on-board-unit (OBU). Each OBU is uniquely associated with a vehicle in which the OBU is mounted, and capable of signaling its presence to other vehicles or dedicated infrastructures.

For example, wireless Electronic Toll Collection (ETC) gates usually work in the following way. An ETC gate sends continuously radio-frequency (RF) signals to the incoming vehicles. The OBU, which is inside an incoming vehicle, receives the RF signals from the gate and sends RF replies with adequate identification. The OBU is most often put inside the vehicle for protection against any harmful damages (weather, theft, . . . ).

Most systems for road user charging use transponders based on Dedicated Short Range Communication (DSRC). Such transponders are mounted in the vehicles and they are generally referred to as on-board-units (OBU).

Because of the masking effect of the metallic car body, and because the incoming RF signals from the tolling gate is ahead of the vehicle, the usual position for the OBU is inside the vehicle, in contact with or stuck on the inside surface of the windshield and pointing in front of the vehicle.

However, the glass thickness of the windshield—up to 5 mm, and more particularly between about 3 mm and 5 mm—is electromagnetically “thick” for such range of RF frequencies, and creates reduction in RF signals (sent and received) that can go up to 3 dB, so up to a loss of 50% of the RF signals.

Furthermore, the windshields of vehicles may include metallic components. It is the case for example of heatable windshields like heatable coated windshields or heatable wired windshields. Both of those windshields are well known. Windshields are laminated glazings, usually made of two glass sheets bound by a thermoplastic layer, usually made of polyvinyl butyral (PVB) or ethylene-vinyl acetate (EVA) substrate. In the case of heated wired windshield, thin conductive metallic wires are usually embedded in the laminate, in contact with the thermoplastic layer, and contacting one of the inner face of one of the glass sheets. Such wires are used to heat the windshield (resistance heating by Joules effect) for defrosting and defogging. These wires are very thin, so as to minimize intrusion into the driver's field of view, and run from side to side or vertically along the windshield, following usually sinusoid-like paths such as described in EP3505405 or EP3379897. However, they create additional reduction in the RF signals received and sent through the windshield.

Such RF signal reductions issues could make that some vehicles are not recorded when passing the ETC gates. Furthermore, regarding other kinds of RF signals that could be received/emitted by a vehicle and coming ahead of its trajectory, for instance for V2X communication (in particular V2P for security of ahead pedestrians, V2I-V2V in case of danger occurring ahead of the vehicle etc.), such RF signals attenuations could endanger the vehicle users or pedestrians.

It would be desirable to have a solution to solve these RF signals reduction issues.

U.S. Pat. No. 6,559,419 discloses a coated windshield. A coated windshield is an alternative to a heated wires windshield, where the wires are replaced by a metallic coating. This coated windshield has a coating-free area, meaning that the coating can be either not deposited in a specific area, or removed from the same specific area. Such decoating allows for better transmission of signals through that portion of the window, for example for a toll device.

EP3516926 discloses a heatable window for a vehicle with embedded wires in the laminate. The window has a wired area, wherein the wires may have a sinusoidal shape and an adapted pitch (distance between each wire). In the same way as of a coated windshield, this heated wires windshield also comprises a wire-free area, meaning an area where no wires have been placed or where such wires have been removed. This wire-free area allows data to be transmitted through the window to a device positioned in the vicinity of the wire-free area, including a signal receiving device or a signal transmitting device.

However, creating a wire-free area in a vehicle glazing requires additional manufacturing steps, which can lead to increase of time to produce the vehicle glazing, as well as complexifying the whole process.

Finally, the OBU has to be placed in the wires-free area exactly. As the OBU is usually placed by the common one, it may lead to wrong position of the OBU, and therefore to improper functioning of the device.

### SUMMARY OF THE INVENTION

The present invention concerns a vehicle laminated glazing configured to be used in front of an on-board-unit able to emit and receive radio-frequency signals in the 5.9 GHz band. More particularly, the present invention concerns a heatable wired laminated glazing. The vehicle laminated glazing comprises conductive wires configured to heat the vehicle laminated glazing. These conductive wires have a specific wave factor (WF) defined as the ratio between the wire length (L) over one period and the wavelength (λ). These conductive wires (2) are spaced by a pitch (P) comprised between

$${P}_{min} = \frac{2.9}{WF + 0.1} + 0.3 and {P}_{max} = \frac{4.3}{WF + 0.1} + 0.5 .$$

The present invention further concerns a vehicle comprising such vehicle laminated glazing, as well as the use of such vehicle laminated glazing to allow radio-frequency signals in the 5.9 GHz band from and to an on-board-unit.

The present invention further concerns an assembly comprising such a vehicle laminated glazing and at least one on-board unit configured to emit and receive radio-frequency signals in the 5.9 GHz band.

The present invention further concerns a vehicle comprising such assembly, as well as a method to produce such assembly.

### BRIEF DESCRIPTION OF THE DRAWINGS

The invention will now be described further, byway of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1a illustrates the concept of wave factor (WF), while FIG. 1b illustrates the pitch.

FIG. 1c and FIG. 1d illustrates sinusoidal paths made of respectively triangles or squares.

FIG. 2 illustrates a windshield of a vehicle.

FIG. 3 illustrates a vehicle laminated glazing according to the present invention.

FIG. 4 illustrates radiation patterns.

FIG. 5 illustrates the wave factor/pitch values according to the invention.

FIG. 6 illustrates the test setup for the radiation measurement.

FIG. 7 illustrates the radiation test result for the wave factor of 1.1 and the pitch of 4 with a reference to a clear glass.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a wired vehicle laminated glazing. A vehicle includes car, van, lorry, motorbike, bus, tram, train, drone, airplane, helicopter and the like.

A laminated glazing refers to at least two sheets of glass being laminated with an interlayer. The sheets of glass can be made of (mineral) glass, more specifically a silica-based glass, such as soda-lime-silica, alumino-silicate or boro-silicate type glass. The interlayer is usually made of polyvinyl butyral (PVB) or ethylene-vinyl acetate (EVA).

The vehicle laminated glazing is configured to be used in front of an on-board-unit (OBU) able to emit and receive radio-frequency (RF) signals in the 5.9 GHz band. The OBU is configured to be placed on the internal face of the vehicle laminated glazing. Here, “internal” means the face of the vehicle laminated glazing in contact with the interior of the vehicle. The OBU can for example be stuck on the vehicle laminated glazing with a double-sided adhesive tape or by suction means. The OBU can also be placed by any other connecting means known in the art.

According to the present invention, the vehicle laminated glazing is a heatable wired laminated glazing. In order to heat the vehicle laminated glazing (to defrost and/or defog) conductive wires are embedded in the vehicle laminated glazing, in contact with the thermoplastic layer, and contacting one of the inner face of one of the glass sheets. The conductive wires are usually made of tungsten or copper. These wires are very thin, generally of a width comprised between 10 microns and 50 microns. They usually run vertically or from side to side along the vehicle laminated glazing.

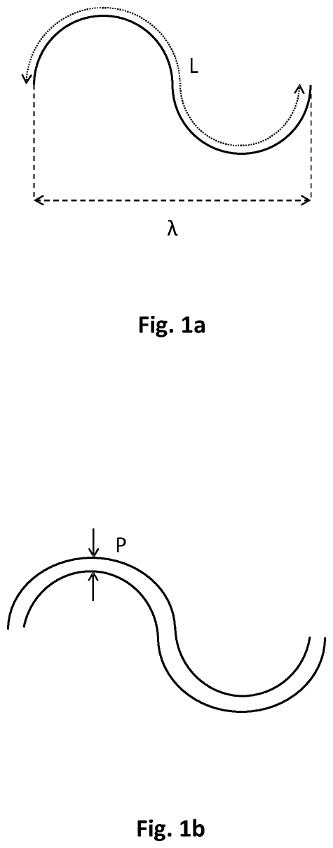

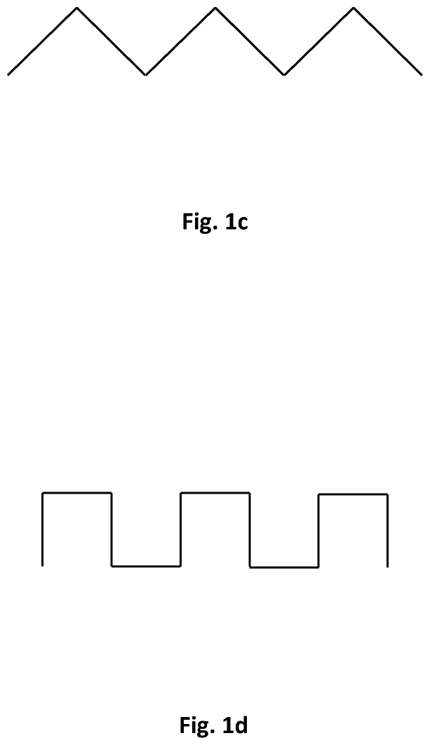

Conductive wires usually follow straight or sinusoid-like paths. The wave factor parameter is linked to the waviness of the wires. As illustrated in FIG. 1a, the wave factor (WF) is defined by the ratio between the wire length (L) over one period and the wavelength (λ). A wave factor of 1 corresponds to a straight wire. The higher the wave factor, the tighter the sinusoidal shape. By sinusoid-like it is referenced to a sinusoidal path. It therefore also applies to a sinusoidal path made of, for example, triangles (such as illustrated in FIG. 1c) or squares (such as illustrated in FIG. 1d), as long as a wave factor can be defined.

As illustrated in FIG. 1b, the distance between successive conductive wires is defined as the pitch (P).

It has been surprisingly determined that if the pitch (P) is comprised between

$${P}_{min} = \frac{2.9}{WF + 0.1} + 0.3 and {P}_{max} = \frac{4.3}{WF + 0.1} + 0.5 . ,$$

then the RF signals in the 5.9 GHz band (from 5.85 to 5.93 GHz), instead of being reduced by the conductive wires are to the contrary transmitted, and can even be enhanced. It therefore allows the OBU to function properly, even if conductive wires are indeed present in the vehicle laminated glazing placed in front of the OBU.

In a preferred embodiment, the wave factor (WF) of the conductive wires is comprised as higher than 1.0 and up to 3.0, i.e., between 1.0 and 3.0 excluding 1.0. A value of 1.0 corresponds to a straight conductive wire, without sinusoidal shape and which is not part of the invention. A value of 3.0 corresponds to very noticeable sinusoidal shape. This value range, i.e., 1.0<WF≤3.0 is chose so as to minimize the visual impact on the drive of the vehicle. It also allows to decrease diffraction, for example from light coming from headlights from another crossing vehicle.

In a preferred embodiment, the vehicle laminated glazing is a windshield or a rearlite of a vehicle. These glazings are the most adapted to the use of an on-board unit.

The present invention also proposes a vehicle comprising at least one vehicle laminated glazing as described previously.

The present invention also proposes the use of a vehicle laminated glazing as described previously to allow radio-frequency signals in the 5.9 GHz band from and to the at least one on-board-unit.

The present invention also proposes an assembly comprising a vehicle laminated glazing as described previously. The assembly further comprises at least one on-board-unit. The at least one on-board-unit is configured to be stuck on the internal face of the vehicle laminated glazing. The at least one on-board-unit is also configured to emit and receive radio-frequency signals in the 5.9 GHz band.

In a preferred embodiment, the at least one on-board-unit of the assembly is an e-tolling device. An e-tolling device is particularly adapted to such kind of use.

In a preferred embodiment, the at least one on-board-unit is glued on the internal face of the vehicle laminated glazing by double-sided adhesive tape. The at least one on-board unit can able be sucked on the internal face of the vehicle laminated glazing by suction means. Other ways to attach the at least one on-board unit to the internal face of the vehicle glazing includes but are not restricted to brackets.

The present invention also proposes a vehicle comprising at least one assembly as described previously.

The present invention also proposes a method to produce an assembly as described previously. The method comprises the steps of laminating at least two sheets of glass with a wired interlayer to form a vehicle laminated glazing according to the present invention. The conductive wires are commonly embedded into the interlayer used to form the vehicle laminated glazing. The conductive wires have a specific wave factor (WF) defined as the ratio between the wire length (L) over one period and the wavelength (λ), wherein the wave factor (WF) is comprised as 1.0<WF≤3.0. The conductive wires (2) are spaced by a pitch (P) comprised between

$${P}_{min} = \frac{2.9}{WF + 0.1} + 0.3 and {P}_{max} = \frac{4.3}{WF + 0.1} + 0.5 .$$

Then at least one on-board-unit is placed on the internal face of the vehicle laminated glazing.

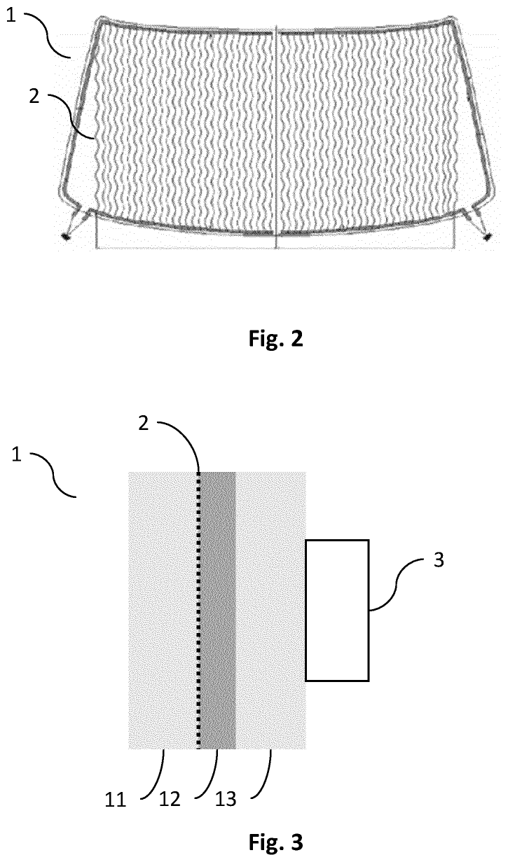

FIG. 2 illustrates a windshield (1), which is a vehicle laminated glazing (1). This vehicle laminated glazing (1) is equipped with conductive wires (2). In this illustration the conductive wires (2) are placed vertically, but they can also be placed horizontally or along any other orientation.

Referring to FIG. 3, the vehicle laminated glazing (1) is formed of at least two sheets of glass (11, 13) laminated together by an interlayer (12). Conductive wires (2) are embedded into the interlayer (12) used to form the vehicle laminated glazing (1). These conductive wires (2) embedded into the interlayer may face the external glass sheet (11) as illustrated in the figure, or face the internal glass sheet (13). An OBU (3) is placed on the internal face of the vehicle laminated glazing (1), and therefore behind the conductive wires.

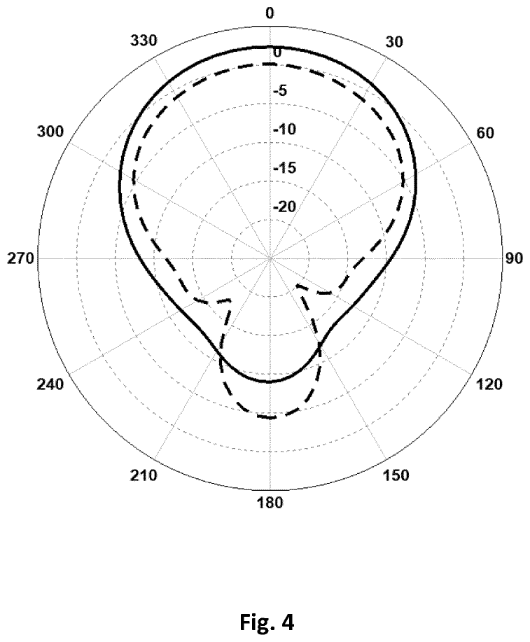

FIG. 4 illustrates the positive impact of the conductive wires (1) on the transmission of RF signal in the 5.9 GHz band. The dotted line shows the radiation pattern through a laminated glazing (1) of a 5.9 GHz antenna located just behind the glazing. The laminated glazing (1) is formed of two glass sheets (11, 13) of 2.1 and 1.6 mm, laminated by an interlayer (12) of 0.76 mm. The relative permittivity of the laminated glazing (1) at 5.9 GHz is equal to 6.8. The plain line shows the radiation pattern of the same antenna through a similar laminated glazing (1) with conductive wires (2). The pitch of the conductive wires (2) is equal to 2.5, while the wave factor is equal to 1.47. As can be seen on FIG. 4, when the laminated glazing (1) is equipped with conductive wires (2), the RF signal is stronger in all forward directions, i.e. between −90° and +90°, while it is weaker only in the backward directions (between 150° and 210°) indicating a better transmission through the laminated glazing (1) with lower back reflections.

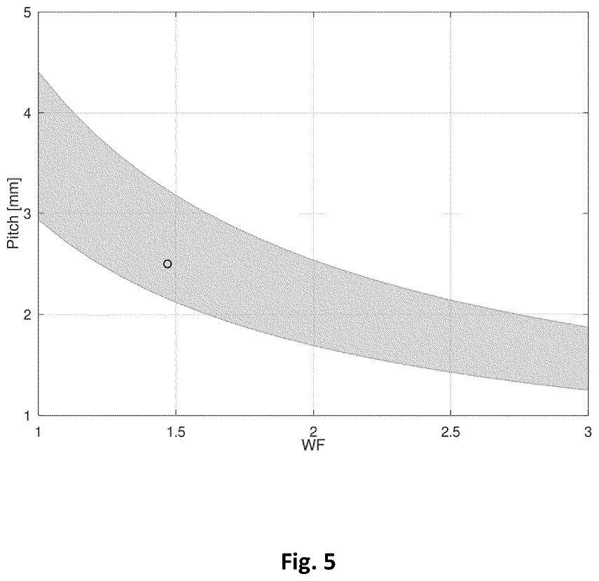

FIG. 5 shows, on a graph presenting the pitch/wave factor values according to the present invention (highlighted zone on the graph itself), the point corresponding to the previous cited example, with a pitch of the conductive wires (2) equal to 2.5, and a wave factor equal to 1.47.

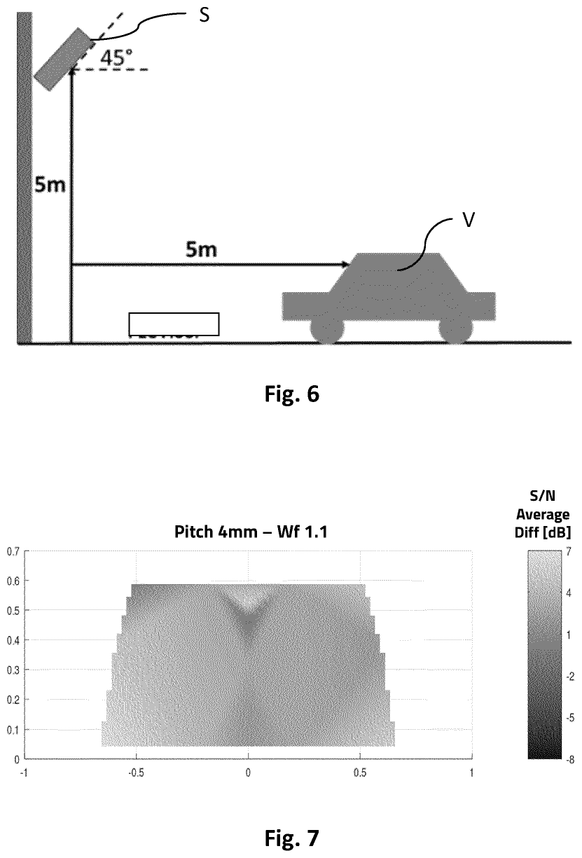

FIG. 6 shows the test setup for the radiation measurement. A vehicle (V) is set in an anechoic chamber and an on-board-unit (OBU) emitting and receiving radio-frequency (RF) signals in the 5.9 GHz band is fixed to the windshield of the vehicle (V) from inside as described above. A sensor (S), which able to emit and receive RF signals in the 5.9 GHz band, is also placed high above to measure the radiation levels. The vehicle (V) is placed such that the on-board-unit (OBU) is set to be horizontally 5 meters and vertically 5 meters away from the sensor (S), which is the standard case for such measurements and also such setup simulates the real world environment for operation of such an on-board-unit. The sensor (S) is inclined around 45° such that the sensor (S) is facing to the vehicle (V). Different glazings (1) with different wave factor and pitch values are tested in the test setup.

The measurement is done as first with a vehicle (V) with a clear glazing which does not comprise any conductive wires is placed inside the chamber and an OBU is placed on different surfaces of the glazing from inside the vehicle and a RF signal is sent and the transmission is measured by the sensor (S) to provide a baseline. Then, a vehicle (V) with a glazing (1) provided with conductive wires (2) suggested by the present invention is placed inside the chamber and the measurement is repeated in the same way described above.

FIG. 7 shows on a graph that the test result for a glazing comprising conductive wires wherein the conductive wires having a wave factor of 1.1 and pitch of 4. The graph shows the signal-to-noise ratio with referenced to a glazing with no conductive wires, i.e., a clear glass glazing. Various measurement points are taken on the surface of the glazing to draw a full graph for the radiation levels for the whole glazing surface as described in the test procedure above. Therefore, the test result show that an OBU can be placed almost anywhere on the glazing. As it can be clearly seen from the graph that a tremendous improvement for the signal-to-noise ratio in the radiation levels is achieved with the glazing the present invention claims. The graph confirms that the RF signals in the 5.9 GHz band (from 5.85 to 5.93 GHz), instead of being reduced by the conductive wires are to the contrary transmitted, and can even be enhanced by the glazing the present invention provides and indeed an enhancement up to 7 dB is achieved by the test result.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. A heatable wired vehicle laminated glazing configured to be in front of an on-board-unit able to emit and receive radio-frequency signals in a 5.9 GHz band, the vehicle laminated glazing comprising:
conductive wires configured to heat the vehicle laminated glazing, the conductive wires having a wave factor (WF) defined as a ratio between a wire length (L) over one period and a wavelength (λ),
wherein the conductive wires are spaced by a pitch (P) between a
$${P}_{min} = \frac{2.9}{WF + 0.1} + 0.3 and \underline{a} {P}_{max} = \frac{4.3}{WF + 0.1} + 0.5 .$$

2. The heatable wired vehicle laminated glazing according to claim 1, wherein the wave factor (WF) is 1.0<WF≤3.0.

3. The heatable wired vehicle laminated glazing according to claim 1, wherein the vehicle laminated glazing is a windshield or a rearlite of a vehicle.

4. A vehicle, comprising:
at least one vehicle laminated glazing according to claim 1.

5. A method for allowing radio-frequency signals in the 5.9 GHz band from and to the on-board-unit, comprising:
installing the on-board-unit on an internal face of the vehicle laminated glazing of claim 1.

6. An assembly, comprising:
a vehicle laminated glazing according to claim 1; and
at least one on-board-unit configured to be stuck on an internal face of the vehicle laminated glazing,
wherein the at least one on-board-unit is configured to emit and receive radio-frequency signals in the 5.9 GHz band.

7. The assembly according to claim 6, wherein the at least one on-board-unit is an e-tolling device.

8. The assembly according to claim 6, wherein the at least one on-board-unit is glued on the internal face of the vehicle laminated glazing by a double-sided adhesive tape.

9. A vehicle, comprising:
at least one assembly according to claim 6.

10. A method for producing the assembly according to claim 6, comprising:
laminating at least two sheets of glass with at least one interlayer to form a vehicle laminated glazing; the interlayer having embedded conductive wires, the conductive wires having a wave factor (WF) defined as a ratio between a wire length (L) over one period and a wavelength (λ), wherein the wave factor (WF) is 1.0<WF≤3.0, the conductive wires being spaced by a pitch (P) between a
$${P}_{min} = \frac{2.9}{WF + 0.1} + 0.3 and \underline{a} {P}_{max} = \frac{4.3}{WF + 0.1} + 0.5 .$$
installing at least one on-board-unit on the internal face of the vehicle laminated glazing.
